(19) United States
(12) Patent Application Publication
(10) Pub. No.: US 2008/0182012 A1
(43) Pub. Date: Jul. 31, 2008

(54) MICRO FUEL CELL HAVING MACROPOROUS METAL CURRENT COLLECTORS

(75) Inventors: Allison M. Fisher, Chandler, AZ (US); Ramkumar Krishnan, Gilbert, AZ (US); Kajal Parekh, Phoenix, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/669,720

(22) Filed: Jan. 31, 2007

(51) Int. Cl. B05D 5/12

(52) U.S. Cl. 427/115; 427/58

(57) ABSTRACT

A method is provided for fabricating a hybrid gas diffusion layer/current collector/electrocatalyst structure (28) suitable for 3D microfuel cell devices (180). The method comprises forming a macroporous electrically conductive structure (28) on a substrate (12, 112) positioned such that a plurality of cathode current collector/GDL (168) and anode current collector/GDL (166) are formed. An electrocatalyst material (158) is deposited in contact with these structures, completing the formation of cathode (168) and anode (166) hybrid current collector/GDL/electrocatalyst structures. When electrolyte (158) is positioned between the electrocatalyst material (158) contacting the cathode collector (168) and the electrocatalyst material (158) contacting each of the plurality of anode collectors (166), the resulting MEA is suitable for use in a micro fuel cell device.

### RELATED APPLICATIONS

This application relates to U.S. application Ser. No. 11/363,790, Integrated Micro Fuel Cell Apparatus, filed 28 Feb. 2006, U.S. application Ser. No. 11/479,737, Fuel Cell Having Patterned Solid Proton Conducting Electrolytes, filed 30 Jun. 2006, U.S. application Ser. No. 11/519,553, Method for Forming a Micro Fuel Cell, filed 12 Sep. 2006, and U.S. application Ser. No. 11/604,035, Method for Forming a Micro Fuel Cell, filed 20 Nov. 2006.

### FIELD OF THE INVENTION

The present invention generally relates to fuel cells and more particularly to a method of readily providing fuel and oxidant to a micro fuel cell through macroporous current collectors.

### BACKGROUND OF THE INVENTION

Rechargeable batteries are currently the primary power source for cell phones and various other portable electronic devices. The energy stored in the batteries is limited. It is determined by the energy density (Wh/L) of the storage material, its chemistry, and the volume of the battery. For example, for a typical Li ion cell phone battery with a 250 Wh/L energy density, a 10 cc battery would store 2.5 Wh of energy. Depending upon the usage, the energy could last for a few hours to a few days. Recharging always requires access to an electrical outlet. The limited amount of stored energy and the frequent recharging are major inconveniences associated with batteries. Accordingly, there is a need for a longer lasting, easily recharging solution for cell phone power sources. One approach to fulfill this need is to have a hybrid power source with a rechargeable battery and a method to trickle charge the battery. Important considerations for an energy conversion device to recharge the battery include power density, energy density, size, and the efficiency of energy conversion.

Energy harvesting methods such as solar cells, thermoelectric generators using ambient temperature fluctuations, and piezoelectric generators using natural vibrations are very attractive power sources to trickle charge a battery. However, the energy generated by these methods is small, usually only a few milliwatts. In the regime of interest, namely, a few hundred milliwatts, this dictates that a large volume is required to generate sufficient power, making it unattractive for cell phone type applications.

An alternative approach is to carry a high energy density fuel and convert this fuel energy with high efficiency into electrical energy to recharge the battery. Radioactive isotope fuels with high energy density are being investigated for portable power sources. However, with this approach the power densities are low and there also are safety concerns associated with the radioactive materials. This is an attractive power source for remote sensor-type applications, but not for cell phone power sources. Among the various other energy conversion technologies, the most attractive one is fuel cell technology because of its high efficiency of energy conversion and the demonstrated feasibility to miniaturize with high efficiency.

Fuel cells with active control systems and those capable of operating at high temperatures are complex systems and are very difficult to miniaturize to the 2-5 cc volume needed for cell phone application. Examples of these include active control direct methanol or formic acid fuel cells (DMFC or DFAFC), hydrogen fuel cells, reformed hydrogen fuel cells (RHFC), and solid oxide fuel cells (SOFC). Passive air-breathing hydrogen fuel cells, passive DMFC or DFAFC, and biofuel cells are attractive systems for this application. However, in addition to the miniaturization issues, other concerns include supply of hydrogen for hydrogen fuel cells, lifetime and energy density for passive DMFC and DFAFC, and lifetime, energy density and power density with biofuel cells.

Conventional hydrogen, DMFC and DFAFC designs comprise planar, stacked layers for each cell, including current collectors, gas diffusion layers (GDLs), electrocatalyst layers, and proton conducting membrane (electrolyte). The combination of GDLs, electrocatalyst layers, and proton conducting membrane is known in the art as a membrane-electrode-assembly (MEA). Many methods have been reported for fabricating MEAs for conventional fuel cells, and many types of MEAs are commercially available. In a typical fabrication, an electrocatalyst supported on carbon is dispersed with an ionomer, Nafion® for example, and is either coated on both sides of the electrolyte directly, or applied to one side of a GDL which is then hot-pressed to the electrolyte, or simple assembled with an electrolyte in some test hardware. While this mixture of electrocatalyst/carbon support/ionomer achieves a three point contact between fuel, electron conductor, and proton conductor, the number of three point contacts varies widely according to the fabrication method used, and can thereby limit oxygen reduction reaction kinetics and the maximum power available from the fuel cell. Furthermore, the thickness of the catalyst/carbon support/ionomer is often greater than ten micrometers and contributes to increased iR losses that result in a voltage drop that lowers the power output of the fuel cell. Fuel and water diffusion through the electrocatalyst layer is poor (permeability of less than 0.1), resulting in mass-transfer limitations which also decrease the power available from the cell.

For most applications, individual cells are stacked for higher power, redundancy, and reliability. Stack hardware typically comprises graphite, carbon or carbon composites, polymeric materials, metal such as titanium and stainless steel, and ceramic. The functional area of the stacked layers is restricted, usually on the perimeter, by vias for bolting the structure together and accommodating the passage of fuel and an oxidant along and between cells. Additionally, the planar, stacked cells derive power only from a fuel/oxidant interchange in a cross-sectional area (x and y coordinates).

In order to design a fuel cell/battery hybrid power source in the same volume as a typical mobile device battery (10 cc-2.5 Wh), both a smaller battery and a fuel cell with high power density and efficiency would be required to achieve an overall energy density higher than that of the battery alone. For example, for a 4-5 cc (1.0-1.25 Wh) battery to meet the peak demands of the phone, the fuel cell would need to fit in 1-2 cc, with the fuel taking up the rest of the volume. The power output of the fuel cell needs to be 0.5W or higher to be able to recharge the battery in a reasonable time. Most development activities on small fuel cells are attempts to miniaturize traditional fuel cell designs, and the resultant systems are still too big for mobile applications. A few micro fuel cell development activities have been disclosed using traditional silicon processing methods in planar fuel cell configurations, and in a few cases, porous silicon is employed to increase the surface area and power densities. See, for example, U.S. Patent/Publication Numbers 2004/0185323, 2004/0058226, U.S. Pat. No. 6,541,149, and 2003/0003347. However, the power densities of the air-breathing planar hydrogen fuel cells are typically in the range of 50-100 mW/cm², and to produce 500 mW with this device would require 5 cm² or more active area. Further, the operating voltage of a single fuel cell is in the range of 0.5-0.7V. At least four to five cells would need to be stacked in series to bring the fuel cell operating voltage to 2-3V and for efficient DC-DC conversion to 4V in order to charge the Li ion battery. Therefore, the traditional planar fuel cell approach will not be able to meet the requirements in a 1-2 cc volume for a fuel cell in the fuel cell/battery hybrid power source for cell phone use.

Meeting the challenges of a fuel cell battery hybrid power source for a cell phone requires a redesign of the traditional fuel cell. One approach is to design a 3D fuel cell, rather than a planar (2D) fuel cell. With sufficient aspect ratio and geometry, it would be possible to build a stack of hundreds of cells in series in the 1-2 cc space defined by the portable device. However, traditional methods of MEA and fuel cell fabrication are not viable for fabricating a micron-sized, 3D fuel cell. Therefore, viable methods for the fabrication of high aspect ratio, micron sized 3D membrane electrode assemblies suitable for use in a fuel cell/battery hybrid power source are needed.

In a microfabricated fuel cell, typically, good passive diffusion of fuels to the catalyst active surface must be enabled while permitting the exit of water from the electrode regions. Stacked structures such as described in 2004/0185323, 2004/0058226, U.S. Pat. No. 6,541,149, and 2003/0003347, are designed to facilitate this passive diffusion and exit of water. However, for known micro 3-D fuel cell with anodes and cathodes arranged in the same plane of the substrate, the microporous metal limits the amount of water migration. Therefore a method of fabrication and structure is needed that overcomes these issues.

Accordingly, it is desirable to provide a method of fabrication of a hybrid gas diffusion layer/current collector and electrocatalyst layer and structures suitable for 3D microfuel cell power sources. This invention is illustrated in the fabrication of an integrated micro fuel cell apparatus that derives power from a three-dimensional fuel/oxidant interchange having increased surface area and readily provide fuel and oxidant to a micro fuel cell through current collectors. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for fabricating a fuel cell wherein fuel and oxidant is readily provided to a micro fuel cell through macroporous current collectors. The method comprises assembling an electrode of an energy generation device comprising forming a porous conductive material, conformally coating the porous conductive material with a catalyst layer comprising one or more materials that are electrically and ionically conductive; and conformally forming an electrolyte layer on the catalyst layer.

### BRIEF DESCRIPTION OF THE DRAWINGS

An exemplary embodiment of the present invention will hereinafter be described in conjunction with the following drawing figures, wherein like numerals denote like elements, and

FIGS. 1-6 are cross-sectional views illustrating a process for fabricating a porous metal on a substrate in accordance with an exemplary embodiment;

FIG. 7 is a cross-sectional view of a single void within the porous metal of FIG. 6 in accordance with an exemplary embodiment;

FIG. 8 is a cross-sectional view of a single void within the porous metal of FIG. 6 in accordance with another exemplary embodiment;

FIGS. 9-15 and 17-21 are partial cross-sectional views of two fuel cells as fabricated in accordance with an exemplary embodiment;

FIG. 16 is a partial cross-sectional top view taken along the line 16-16 of FIG. 15; and

FIG. 22 is a partial cross-sectional top view taken along the line 21-21 of FIG. 22.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The main components of a fuel cell device are a proton conducting electrolyte separating the reactant gases of the anode and cathode regions, an electrocatalyst which helps in the oxidation and reduction of the gas species at the anode and cathode of the fuel cell, a gas diffusion layer (GDL) to provide uniform reactant gas access to the anode and cathode and removal of gaseous or liquid by-products from the electrocatalyst, and a current collector for efficient collection and transportation of electrons to a load connected across the fuel cell. In traditional fuel cells, the membrane-electrode assembly comprises a sandwich structure of cathode GDL and cathode elecrocatalyst, proton conducting electrolyte membrane, anode electrocatalyst, and anode GDL. The electrocatalyst is a hybrid material composed of catalyst, e.g., platinum or platinum supported on carbon, as well as platinum alloys, and ionomer, which is applied as an “ink” in water/alcohol solvent either directly to each side of the proton conducting electrolyte, or to the gas diffusion materials. Application of the electrocatalyst can be done by hand, spraying, inkjet printing, casting, or other methods known in the art. In the case of the former, gas diffusion material is added to each side, often by hot-pressing, and in the latter, the electrocatalyst-coated gas diffusion material is placed against each side of the proton conduction electrolyte, often with hot-pressing. As the dimensions of the fuel cell device decrease to the realm of micro fuel cells, it is increasingly difficult, and ultimately impossible, to employ these methods for the fabrication of a membrane electrode assembly. As with traditional, larger fuel cells, in fabrication of the micro fuel cell structures, the design, structure, and processing of the electrolyte and electrocatalyst are critical to high energy and power densities, and improved lifetime and reliability. Few methods have been described in the literature for the fabrication of a microfuel cell with dimensions less than the millimeter scale, and few of these methods are amenable to 3D geometries. A process is described herein to fabricate a macroporous 3D microstructure which functions as a hybrid current collector, gas diffusion layer and electrocatalyst for use in microfuel cell devices. The improved surface area of the high aspect ratio 3D micro fuel cell is expected to result in enhanced electrochemical contact area, improved 3-point contact, and lower iR losses compared to traditional current collector-GDL-electrocatalyst structures. The three-dimensional fuel cell may be integrated as a plurality of micro fuel cells.

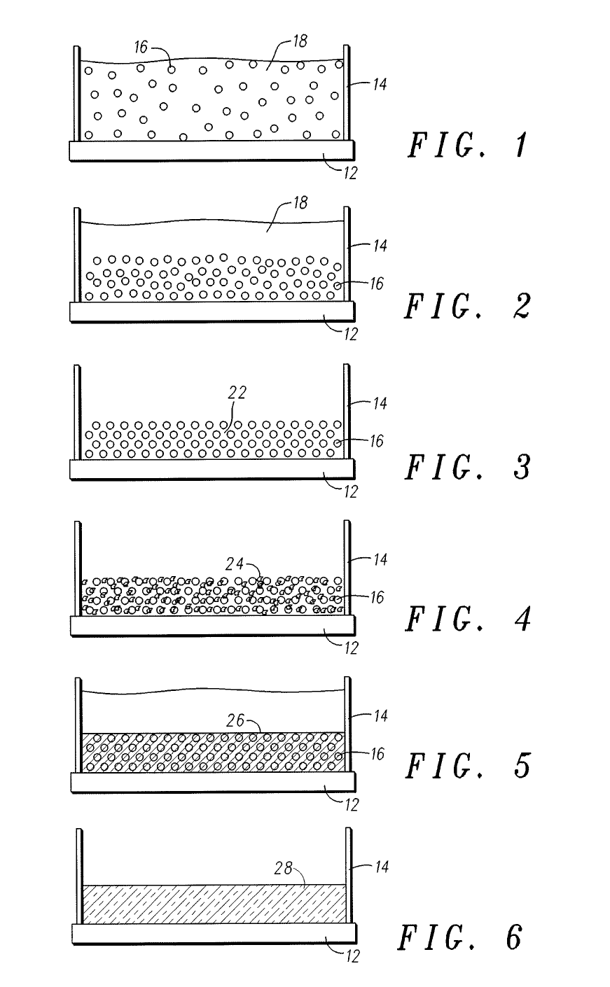

In one exemplary embodiment, a method for fabricating the macroporous GDL-electrocatalyst structure includes preparing a macroporous conducting substrate, followed by surface or pore coating with the electrocatalyst layer. Macroporous materials are defined by International Union of Pure Applied Chemistry (IUPAC) are ordered structures with pore diameters greater than 50 nm and are reviewed by Guliants et. al. (J. Membrane Science, 2004, 235, 53, and references cited therein). These materials are most frequently made by a macroscale templating approach described hereinafter. FIGS. 1-6 show the steps used for the fabrication of an ordered electrically conducting structure that forms the base for coating with an electrocatalyst layer. Referring to FIG. 1, a colloidal crystal template 18 is formed on a conductive substrate 12 within container walls 14 by placing particles 16, e.g., spheres (FIG. 1), comprising latex or silica, for example, of precisely controlled diameter, within a solution 18 using depositions methods (FIG. 2) such as sedimentation, centrifugation, vertical or horizontal deposition, or electrophoresis that are known in the art. The solution 18 is removed (FIG. 3), by evaporation, for example. Referring to FIG. 4, the interstitial spaces 22 of the ordered spheres 16 are filled with precursors of conductive materials 24, such as metal salts (for example, see Colvin, et. al. (add) and Bartlett, et. al. Chem. Mater. 2002, 14, 2199) or organic materials such as resorcinol-formaldehyde sol-gel carbon precursor known to provide conductive carbon after pyrolysis (Wang, et. al. Chem. Mater. 2005, 17, 6805). In the case of the metal salts (referring to FIG. 5), the metal salts are reduced to conductive metal 26 using one of the methods such as electroplating, electroless plating, and chemical reduction. Referring to FIG. 6, the spheres are removed by calcinations or solvent extraction, for example. The resulting macroporous structure 28 is highly ordered with precisely controlled pore sizes (void) 25 defined by the sphere size and excellent pore connectivity.

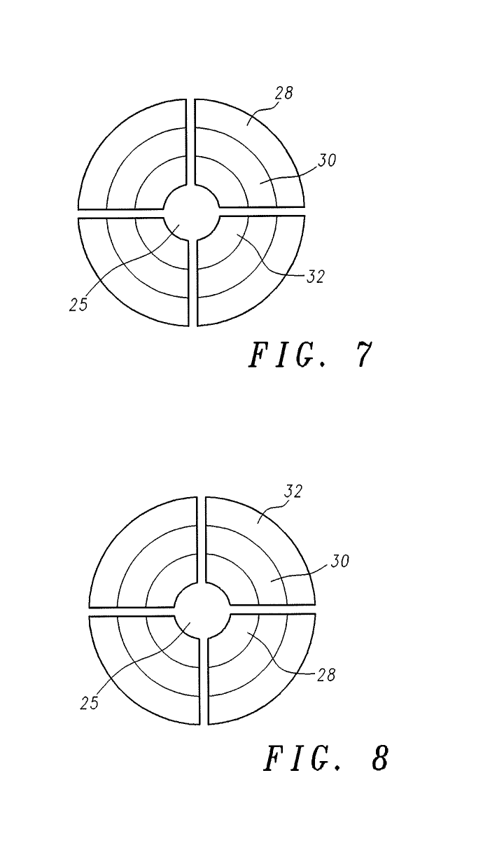

Once the macroporous conductive substrate 28 is fabricated, surface and/or pore coating is carried out to deposit the electrocatalyst conformally. A variety of methods can be used for deposition of the electrocatalyst layer, depending on the properties required by the device. For example, after deposition of a porous Au layer, the substrate surface is modified selectively with a self-assembled monolayer (SAMs). The sidewalls and internal walls of the porous metal layer are coated with hydrophilic SAMs such as cysteamine and 2-mercaptoethanesulfonic acid, which put a —NH2 and —SO3H group at the surface, respectively. The electrocatalyst layer is fabricated on the hydrophilic regions using self-assembly methods, e.g., layer by layer assembly, electrophoretic deposition, electrochemical deposition, atomic layer deposition, or vapor deposition. For example, a dilute colloid of catalyst, and anionic polyelectrolyte such as Nafion®, with or without additional carbon can be deposited alternately with a dilute colloid of cationic polyelectrolyte (such as polyvinylimidazole) with or without catalyst, and carbon. Alternatively, a method can be used with the appropriately functionalized catalyst nanoparticles to form a covalently networked nanoparticle film on the hydrophilic regions (Tognarelli, et. al. Langmuir 2005, 21, 11119-11127). Additionally, an electrolyte layer may be deposited over the electrocatalyst layer to increase the ionic conductivity of the hybrid structure. The porosity, thickness and the total surface area of the macroporous conducting layer can be controlled by the experimental conditions to achieve a high surface area catalyst support with good gas diffusion properties, high number of 3-point contacts as well as low electronic ohmic loss. FIG. 7 shows the hybrid structure. The electrocatalyst 30 is formed between the macroporous structure 28 and the electrolyte 32 as described above. It should be noted that even with conformal layers, the structure is still permeable to gasses and liquids in the void 25.

In another approach, a macroporous electrolyte layer is formed on a substrate by using template assisted methods. For example, a polymer electrolyte is formed in the voids around the template formed by assembly of particles, e.g., latex or silica. After removal of the template, a macroporous electrolyte membrane is formed. Once the macroporous electrolyte is fabricated, surface and/or pore coating is carried out to deposit the electrocatalyst conformally. A variety of methods can be used for deposition of the electrocatalyst layer, depending on the properties required by the device. The sidewalls and internal walls of the porous electrolyte may be coated with a more uniform hydrophilic layer such as polyvinylimadiazole, which put a uniform hydrophilic polyelectrolyte on the surfaces. The electrocatalyst layer is fabricated conformally on the hydrophilic regions using self-assembly methods, e.g., layer by layer assembly, electrophoretic deposition, electrochemical deposition, atomic layer deposition, or vapor deposition. A thin porous conducting gas diffusion layer is then formed on the catalyst layer inside the pores by chemical or electrochemical methods such as selective dealloying and electrophoresis. FIG. 8 shows this hybrid structure. The electrocatalyst 30 is formed between the macroporous structure 28 and the electrolyte 32 as described above. It should be noted that even with conformal layers, the structure is still permeable to gasses and liquids in the void 25.

Hybrid structures described above can then be used in the fabrication of conventional micro fuel cells or micro fuel cells comprising high aspect ratio three dimensional anodes and cathodes with sub-100 micron dimension. Such devices provide a high surface area with good three point contact and high catalyst utilization. At these small dimensions, precise alignment of the anode, cathode, electrolyte and current collectors is required to prevent shorting of the cells. This alignment may be accomplished by semiconductor processing methods used in integrated circuit processing. Functional cells may also be fabricated in ceramic, glass or polymer substrates. This method of fabricating a three-dimensional micro fuel cell has a surface area greater than the substrate and, therefore, higher power density per unit volume. A more detailed description to illustrate the use of the hybrid structure of this invention follows.

The fabrication of integrated circuits, microelectronic devices, micro electro mechanical devices, microfluidic devices, and photonic devices, involves the creation of several layers of materials that interact in some fashion. One or more of these layers may be patterned so various regions of the layer have different electrical or other characteristics, which may be interconnected within the layer or to other layers to create electrical components and circuits. These regions may be created by selectively introducing or removing various materials. The patterns that define such regions are often created by lithographic processes. For example, a layer of photoresist material is applied onto a layer overlying a wafer substrate. A photomask (containing clear and opaque areas) is used to selectively expose this photoresist material by a form of radiation, such as ultraviolet light, electrons, or x-rays. Either the photoresist material exposed to the radiation, or that not exposed to the radiation, is removed by the application of a developer. An etch may then be applied to the layer not protected by the remaining resist, and when the resist is removed, the layer overlying the substrate is patterned. Alternatively, an additive process could also be used, e.g., building a structure using the photoresist as a template.

Parallel micro fuel cells in three dimensions fabricated using optical lithography processes typically used in semiconductor integrated circuit processing just described produces fuel cells with the required power density in a small volume. The cells may be connected in parallel or in series to provide the required output voltage. Functional micro fuel cells are fabricated in micro arrays (formed as pedestals) in the substrate. The anode/cathode ion exchange occurs in three dimensions with the anode and cathode areas separated by an insulator. Gasses comprising an oxidant, e.g., ambient air, and a fuel, e.g., hydrogen, are supplied on opposed sides of the substrate. A porous barrier is created between a porous metal in the hydrogen receiving section and the electrocatalyst. A vertical channel (via) is created by front side processing before fabricating the fuel cell structure on the top allow the precise alignment of the hydrogen fuel access hole under the anode, with this method, without the need for higher dimensional tolerances required for the front to back alignment process, allows for the fabrication of much smaller size high aspect ratio cells.

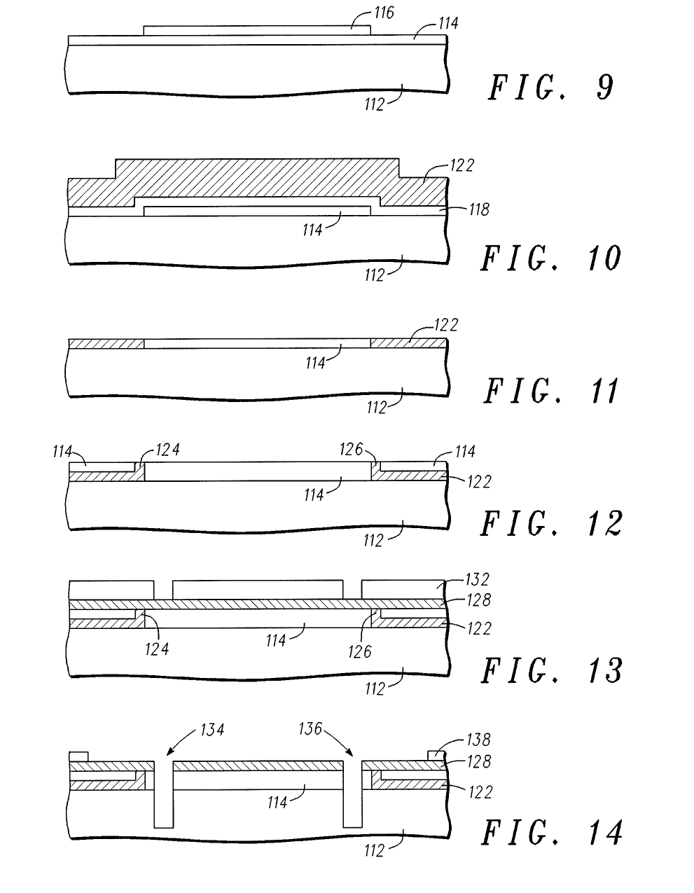

The exemplary embodiment described herein illustrate exemplary processes wherein a macroporous current collector is created in the hydrogen receiving section and/or the oxidant section in the fabrication of fuel cells with a semiconductor-like process on silicon, glass, ceramic, plastic, metallic, or a flexible substrate. Referring to FIG. 9, a thin layer 114 of insulating film, preferably a TEOS oxide or Tetraethyl Orthosilicate (OC₂H₅)₄, is deposited on a substrate 112 to provide insulation for subsequent metallization layers which may be an electrical back plane (for I/O connections, current traces, etc.). The thickness of the thin layer 114 may be in the range of 0.1 to 1.0 micrometers, but preferably would be 0.5 micrometers. An optional insulating layer may be formed between the substrate 112 and the thin layer 114. A photoresist 116 is formed and patterned (FIG. 9) on the TEOS oxide layer 114 and the TEOS oxide layer 114 is etched (FIG. 10) by dry or wet chemical methods. The photoresist 116 is removed and a tantalum/copper layer 118, for example, is deposited on the substrate 112 and the TEOS oxide layer 114 to act as a seed layer for the deposition of a metal layer 122 for providing contacts to elements described hereinafter. The thickness of the tantalum/copper layer 118 may be in the range of 0.05 to 0.5 micrometers, but preferably would be 0.1 micrometers. The metal layer 122 may have a thickness in the range of 0.05-2.0 micrometer, but preferably is 1.0 micrometer. Metals for the metal layer 122 may include, e.g., gold, platinum, silver, palladium, ruthenium, and nickel, but preferably would comprise copper.

The metal layer 122 is patterned with a chemical mechanical polish (FIG. 11), and further similar processing in a manner known to those skilled in the art resulting in the formation of vias 124, 126 integral to the metal layer 122 (FIG. 12). It should be noted that a lift off based process may be used to form the patterned layer 122 and vias 124, 126.

Referring to FIG. 13, in accordance with the exemplary embodiment, an etch stop film 128 having a thickness of about 0.1 to 10.0 micrometers is formed by deposition on the TEOS oxide layer 114 and the vias 124, 126. The film 128 preferably comprises titanium/gold, but may comprise any material to selectively deep silicon etch. Another photoresist 132 is formed and the pattern is transferred from the photoresist layer 132 to layer 128 and subsequently to layer 114 by wet or dry chemical etch processes. A deep reactive ion etch is performed to create channels 134, 136 (FIG. 14) to a depth within the substrate 112 of between 5.0 to 100.0 micrometers, for example. The channels 134, 136 preferably have a 1:10 aspect ratio with minimum feature size of 10 micrometers or smaller. The photoresist 132 is then removed using a chemical etch or calcinations, for example. A second metal layer 138 is formed and patterned on the etch stop film 128 for providing contacts to elements described hereinafter (alternatively, a lift-off process could be used). The metal layer 138 may have a thickness in the range of 0.01-1.0 micrometers, but preferably is 0.1 micrometers. Metals for the metal layer 138 preferably comprise copper, but may comprise, e.g., gold, platinum, silver, palladium, ruthenium, and nickel.

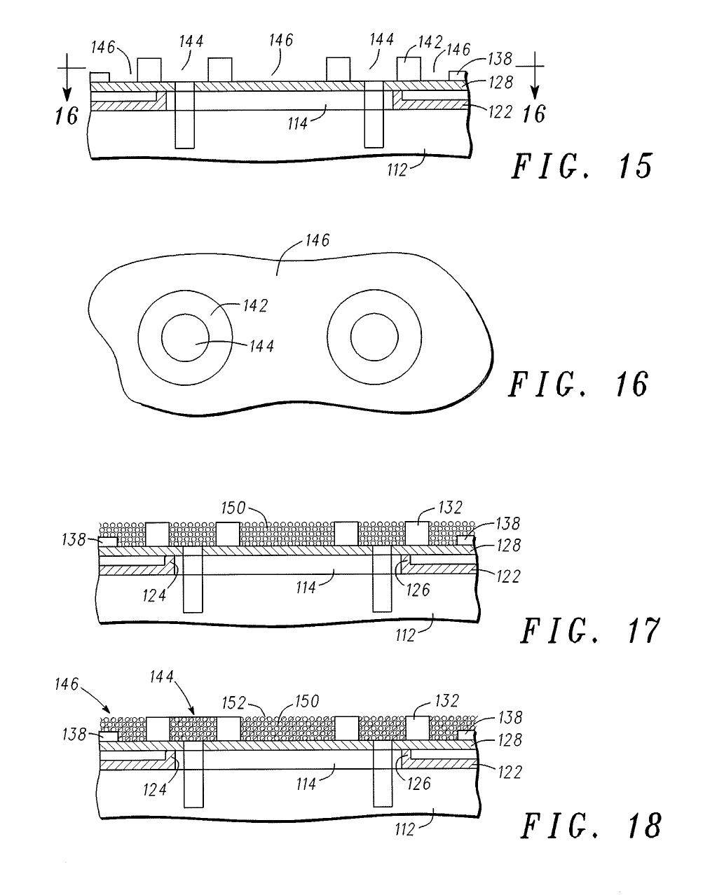

One method of forming anodes/cathodes over the conductive film 128 will now be described. Referring to FIGS. 15 and 16, another photoresist 142 is formed in a pattern to create the opening 144 and a concentric circular channel 146 to a depth of between 5.0 to 100.0 micrometers, for example. A plurality of beads 150 are dispensed (FIG. 17), by suspension for example, in the openings 144 and the circular channel 146 to the height of the photoresist 142. The beads 150 are generally spherical in shape, and though they each typically contact adjacent beads, space exists between the beads 150. The beads 150 preferably comprise polymers such as polystyrene, melamine, polymethylmethacrylate, but may also comprise inorganic beads, for example silica.

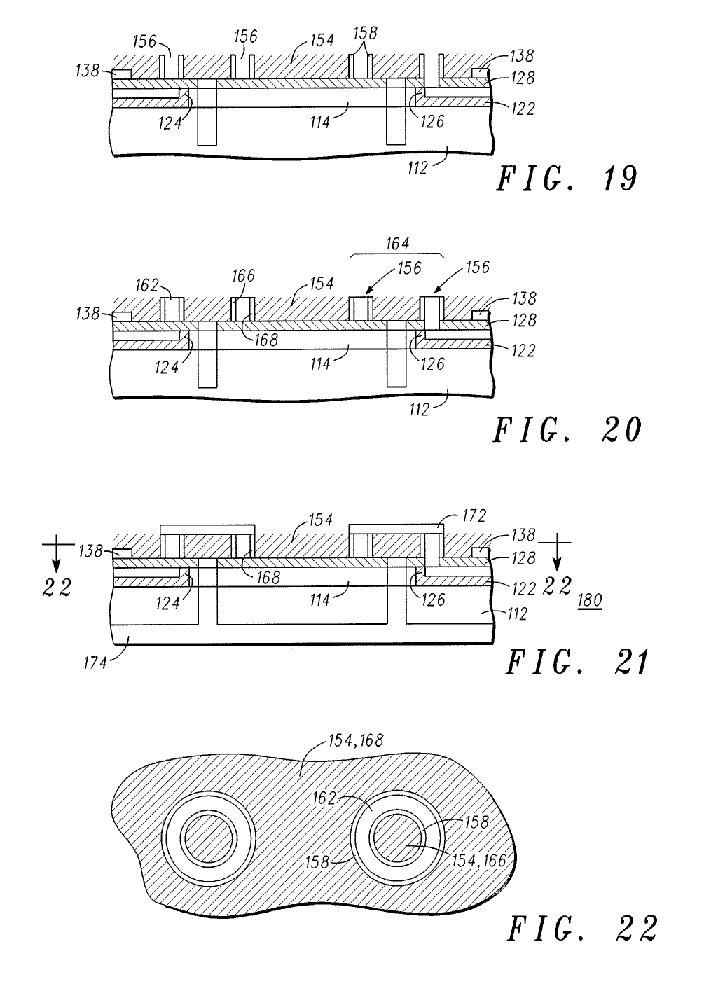

A metal 152 (FIG. 18) is placed, by a plating bath for example, in the openings 144 and circular channels 146 not occupied by the beads 150 (in the space between the beads 150). The metal 152 is preferably gold, but may comprise any metal having an electrochemical standard reduction potential between minus 1.6 and a plus 0.8 volts, and more particularly between a minus 1.0 and a plus 0.34 volts, as the values are generally defined in the industry, for example, at least one of the metals aluminum, nickel, copper, iron, zinc, chromium, cobalt, magnesium, technetium, rhodium, indium, tin, antimony, tellurium, selenium, rhenium, osmium, iridium, mercury, cadmium, lead, and bismuth. In addition to electrochemical deposition, metal can be deposited in the void spaces of the colloidal template using electroless plating processes, ion spraying, or laser spraying. Using still other methods, conductive carbon can be also deposited in the interstitial spaces instead of a metal. The beads 150 are then removed by chemical etching or calcinations, for example by heating in a toluene solvent for polymer beads, or etching with dilute HF for silica beads, thereby leaving a porous conductive structure 154 in each of the openings 144 and circular channels 156 (FIG. 19). The porous conductive structure 154 created by this method defines cavities, or open areas within the porous structure 154, on a macro scale as defined by the International Union of Pure Applied Chemistry (IUPAC). The FUPAC defines macroporous as comprising openings greater than 50.0 nanometers, microporous as comprising openings less than 2.0 nanometers, and mesoporous as comprising openings between 2.0 and 50.0 nanometers. It should be understood that any templated process for creating a fuel cell may be used with the present invention; however, it is intended the porous conductive structure 154 contain macroporous spaces.

Referring to FIG. 20, the photoresist 132 is removed, thereby creating circular channels 156, and porous conductive structure 154 is coated within and on both sides of the circular channels 156 with an electrocatalyst layer 158 for anode and cathodic fuel cell reactions. The electrocatalyst layer 158 can include ionomer in addition to catalyst, and improves anode and cathodic fuel cell reactions and is applied by self-assembly methods such as layer-by-layer deposition, electrodeposition, wash coat, or some other deposition methods such as CVD, PVD or electrochemical methods. The pores of the porous metal 154 is conformally coated with the electrocatalyst layer 158 followed by an electrolyte layer. An electrolyte 162 is formed within the circular channels 156 (FIG. 20), resulting in a pedestal 164 comprising a center anode 166 (inner section), and a concentric cathode 168 (outer section) surrounding and separated by the electrolyte 162 from the anode 166 (FIG. 22). Concentric as used herein means having a structure having a common center, but the anode, cavity, and cathode walls may take any form and are not to be limited to circles. For example, the pedestals 164 may alternatively be formed by etching orthogonal trenches. The pedestal 164 preferably has a diameter of 10 to 100 microns. The distance between each pedestal 164 would be 10 to 100 microns, for example. The electrolyte material 162 may comprise any insulating material with sufficient protonic conductivity to perform as a fuel cell membrane, for example, perfluorosulfonic acids (such as, but not limited to, Nafion®), phosphoric acid, hydrogels, polysulfonic and polyphosphonic polymers or mixtures, ionic liquid electrolytes, organic-inorganic hybrid materials, and proton-conducting inorganic materials. Perfluorosulfonic acid has a very good ionic conductivity (0.1 S/cm) at room temperature when humidified. The electrolyte material also can be a proton conducting ionic liquids such as a mixture of bistrifluromethane sulfonyl and imidazole, ethylammoniumnitrate, methyammoniumnitrate of dimethylammoniumnitrate, a mixture of ethylammoniumnitrate and imidazole, a mixture of elthylammoniumhydrogensulphate and imidazole, flurosulphonic acid and trifluromethane sulphonic acid.

A capping layer 172 is formed (FIG. 21) and patterned above the porous metal 154, to enclose the anode/fuel regions, and the electrolyte material 162. A planning step is performed to reduce the thickness of the substrate 112 and expose the vias 134 and 136. The silicon substrate 112, or the substrate containing the micro fuel cells, is positioned on a structure (gas manifold) 174 for transporting hydrogen to the channels 134, 136. The structure 174 may comprise a cavity or series of cavities (e.g., tubes or passageways) formed in a ceramic material, for example. Hydrogen would then enter the anode/hydrogen sections 166 above the cavities 134, 136. Since anodes 166 are capped with the capping layer 172, the hydrogen would stay within the sections 166. Cathode/oxidant sections 68 are open to the ambient air, allowing air (including oxygen) to enter oxidant sections 168.

The exemplary embodiment disclosed herein provides a method of fabricating a fuel cell having three dimensionally ordered materials, while increasing the surface area for a gas to access the anode material, eliminating constraints on wafer size and thickness, and providing for sub-twenty micron vias for gas access to each cell for increasing cell, and hence, power density. The macrosized current collectors provide controlled pore dimensions with tailored surface chemistry providing for improved hydrophobicity-hydrophilicity for better water management, three point contact between electrocatalyst, current collector, and electrolyte, and reduced iR losses.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method comprising:
assembling an electrode of an energy generation device comprising:
forming a porous conductive material;
conformally coating the porous conductive material with a catalyst layer comprising one or more materials that are electrically and ionically conductive; and
conformally forming an electrolyte layer on the catalyst layer.

2. The method of claim 1 wherein the assembling step comprises forming a colloidal crystal template.

3. The method of claim 1 wherein the conformally coating the catalyst layer step comprises forming the catalyst layer by one of a) chemical deposition from a solution containing catalyst precursors, b) electrodeposition from a solution containing catalyst precursors, c) electrophoretic from a solution containing catalyst precursors, d) layer by layer electrostatic deposition, and e) vapor deposition.

4. The method of claim 3 wherein the forming step comprises forming a conductive material having a porosity defining openings of greater than 50.0 nanometers across.

5. The method of claim 1 wherein the forming step comprises forming the conductive material by one of a) chemical deposition from a solution containing conductive ions, b) electrodeposition from a solution containing conductive ions, and c) vapor deposition.

6. The method of claim 1 wherein the forming step comprises forming a conductive material selected from the group consisting of gold, carbon, platinum, silver, aluminum nickel, copper, iron, zinc, chromium, cobalt, magnesium, technetium, rhodium, cadmium, indium, tin, antimony, tellurium, selenium, rhenium, osmium, iridium, mercury, lead, and bismuth, or alloys thereof.

7. The method of claim 1 wherein the conformally forming an electrolyte layer comprises forming the electrolyte layer by one of a) chemical deposition from a solution containing polymer precursors, b) electrodeposition from a solution containing polymer precursors, and c) layer by layer electrostatic deposition.

8. The method of claim 1 wherein the assembling step comprises forming a plurality of cathode electrodes and a plurality of anode electrodes, the method further comprising positioning an electrolyte between each of the plurality of cathode electrodes and each of the plurality of anode electrodes.

9. A method comprising:
assembling an electrode of an energy generation device comprising:
forming a porous electrolyte layer;
conformally coating the porous electrolyte layer with a catalyst layer comprising one or more materials that are electrically and ionically conductive; and
conformally coating the catalyst layer with a porous conducting material.

10. The method of claim 9 wherein the assembling step comprises forming a colloidal crystal template.

11. The method of claim 9 wherein the conformally coating the porous electrolyte layer comprises forming the catalyst layer by one of a) chemical deposition from a solution containing catalyst precursors, b) electrodeposition from a solution containing catalyst precursors, c) electrophoretic from a solution containing catalyst precursors, d) layer by layer electrostatic deposition, and e) vapor deposition.

12. The method of claim 11 wherein the forming step comprises forming an electrolyte layer having a porosity defining openings of greater than 50.0 nanometers across.

13. The method of claim 9 wherein the conformally coating the catalyst layer comprises forming the porous conductive layer by one of a) chemical deposition from a solution containing conductive ions, b) electrodeposition from a solution containing conductive ions, c) vapor deposition, and d) selective dealloying.

14. The method of claim 9 wherein the conformally coating the catalyst layer step comprises forming a conductive material selected from the group consisting of gold, carbon, platinum, silver, aluminum nickel, copper, iron, zinc, chromium, cobalt, magnesium, technetium, rhodium, cadmium, indium, tin, antimony, tellurium, selenium, rhenium, osmium, iridium, mercury, lead, and bismuth, or alloys thereof.

15. The method of claim 9 wherein the forming step comprises forming the porous electrolyte layer by one of a) chemical deposition from a solution containing polymer precursors, b) electrodeposition from a solution containing polymer precursors, and c) layer by layer electrostatic deposition.

16. A method comprising:
forming a fuel cell with an electrode assembly, comprising:
dispensing a solution onto a substrate, the solution including macroscale size particles;
removing the solution to create an array of particles defining a first void within the array;
filling the first void with a precursor;
reducing the precursor to a conductive material;
removing the plurality of particles, thereby forming a macroporous template comprising the conductive material and defining a second void; and
forming an electrocatalyst within the second void.

17. The method of claim 16 wherein the removing the plurality of particles comprises forming a colloidal crystal template.

18. The method of claim 16 wherein the reducing step forms a conductive material having a porosity defining openings of greater than 50.0 nanometers across.

19. The method of claim 16 wherein the forming a macroporous template comprises:
forming a plurality of cathode collectors and a plurality of anode collectors; and the method further comprising:
positioning an electrolyte between each of the plurality of cathode collectors and each of the plurality of anode collectors.

20. The method of claim 16 further comprising:
forming first and second electrical conductors accessible at a first side of a substrate;
etching the substrate to provide a plurality of channels;
patterning the macroporous template over the first side of the substrate to form a plurality of anode current collectors in contact with the first electrical conductor, and a plurality of cathode current collectors in contact with the second electrical conductor, one each of the plurality of anode current collectors formed over one of the plurality of channels;
depositing an electrolyte between each of the plurality of anode current collectors and each of the plurality of cathode current collectors; and
capping the plurality of anode current collectors on a side opposed to the first side of the substrate.
